(19) United States
(12) Patent Application Publication
(10) Pub. No.: US 2003/0233258 A1
(43) Pub. Date: Dec. 18, 2003

(54) Methods and systems for tracking and accounting for the disclosure of record information

(76) Inventors: Matthew D. Cottrell, American Fork, UT (US); Fred B. Schade JR., Highland, UT (US); Michael G. Colemere, Alpine, UT (US); Mark E. Spjute, Farmington, UT (US); Von G. Landon, Highland, UT (US)

Correspondence Address: John M. Guynn, WORKMAN, NYDEGGER & SEELEY, 1000 Eagle Gate Tower, 60 East South Temple, Salt Lake City, UT, 84111, US

(21) Appl. No.: 10/174,049

(22) Filed: Jun. 18, 2002

(51) Int. Cl. G06F 7/00; G06F 17/30; G06F 17/60

(52) U.S. Cl. 705/3; 707/1

(57) ABSTRACT

Process and system for processing, storing and accounting for the release of medical or other records, the information contained therein, or information relating thereto. The system includes a data processing center which acts as a central clearing house for processing requests for disclosures of verification information from providers who make disclosures of information relating to stored document information, and requests from parties desiring an accounting of such disclosures of information, as in accordance with HIPAA regulations. The data processing center typically associates requests and verification information relating to a release of information with the individuals and providers to which the disclosures of information pertain. The data processing center maintains information relating to disclosures of record information for either a prescribed time period or indefinitely in order to facilitate accountings of disclosure of record information. The communication linkages between the various parties may advantageously include the Internet and/or other electronic connections.

### BACKGROUND OF THE INVENTION

1. The Field of the Invention

The present invention relates to methods and systems for tracking disclosures of record information by a provider to an authorized recipient. More particularly, the invention relates to methods and systems that employ a computerized data processing center which receives, processes and transmits requests for disclosures of record information (e.g., medical record information) to a provider and which receives, processes and stores information relating to such disclosures to facilitate subsequent accountings of disclosure of such record information.

2. The Relevant Technology

There are various businesses and other entities that rely heavily on medical records to make business and other important decisions. These include life insurance companies, property and casualty insurance companies, personal injury attorneys, and patients, which may collectively be referred to as “medical record requestors.” Medical records are typically generated by “providers,” such as doctors, hospitals, clinics and independent diagnostic laboratories. Systems and methods for streamlining the process of requesting a copy of a record and transmitting copies of the records to a requestor are described in U.S. application Ser. No. 09/703,999, filed Nov. 1, 2000, and entitled “Methods and Systems for Retrieval and Digitalization of Records”. For purposes of disclosure, the foregoing application is incorporated by reference.

In general, providers receive numerous requests for medical record information each year and provide corresponding disclosures of information in response to such requests. In addition, providers are often required to spontaneously disclose medical record information in the case of specific medical conditions (e.g., for epidemiological statistics) or patient milestones (e.g., birth and death). Due to privacy concerns and confidentiality rules, providers must typically ensure that a given disclosure of medial record information is authorized (e.g., by the patient or some rule, regulation or law). Once the provider has determined that a disclosure of record information is warranted, the provider must copy or otherwise extract the information to be disclosed and ensure proper refiling of the record. Thus, in addition to providing medical services as their primary business, providers must also control the flow of information generated during the normal course of business. Controlling and monitoring the flow of information generated by providers is itself a daunting task.

To complicate matters, the Federal government passed legislation in 1996, which is not yet implemented, that will greatly complicate the already difficult task of monitoring the flow of information: the Health Insurance Portability and Accountability Act of 1996 (“HIPAA”). The stated purpose of HIPAA is “to improve portability and continuity of health insurance coverage in the group and individual markets, to combat waste, fraud, and abuse in health insurance and health care delivery, to promote the use of medical savings accounts, to improve access to long-term care services and coverage, to simplify the administration of health insurance, and for other purposes.” Preamble to Public Law 104-191 (Aug. 21, 1996). According to HIPAA, Section 1173(d)(i), “The Secretary shall adopt security standards that take into account the technical capabilities of record systems used to maintain health information; the costs of security measures; the need for training persons who have access to health information; the value of audit trails in computerized record systems; and the needs and capabilities of small health care providers and rural health care providers (as such providers are defined by the Secretary); and ensure that a health care clearing house, if it is part of a larger organization, has policies and security procedures which isolate the activities of the health care clearing house with respect to processing information in a manner that prevents unauthorized access to such information by such larger organization.” Section 1173(d)(2) further states that “Each person described in section 1172(a) who maintains or transmits health information shall maintain reasonable and appropriate administrative, technical, and physical safeguards to ensure the integrity and confidentiality of the information; to protect against any reasonably anticipated threats or hazards to the security or integrity of the information; and unauthorized uses or disclosures of the information; and otherwise to ensure compliance with this part by the officers and employees of such person.”

In practice, HIPAA will, among other things, require medical providers to provide an accounting of all disclosures of medical record information for each of its patients, with exclusions for certain types of disclosures. Thus, a patient or other authorized party will, upon request, be able to obtain an exact and detailed accounting from each provider of any and all information disclosed to any third party during a prescribed time period following the disclosure (i.e., 6 years). Sooner or later, all providers large and small will be required by Federal government mandate to supply such accountings upon request. Most providers will be required to comply by Apr. 14, 2003, while smaller health plans that meet certain criteria will essentially have a year grace period. Failure to comply will result in fines of $25,000 (or more) per infraction.

In order to provide the requested accountings of disclosure, providers will now have to precisely track and record certain specified information relating to each and every disclosure of medical record information, whether an actual copy of a record is released or merely a verbal communication, written summary or electronic data transmission of any medical record information of a patient. Moreover, providers will be required to give an accounting of disclosures made from any or all of its facilities, regardless of where the demand for accounting is made (e.g., a patient asks for an accounting of disclosure by a large provider at a local branch and that branch must give an accounting of disclosures by all other branches of that particular provider that may have released medical record information of the patient).

As can plainly be seen, providers, especially large providers, will be required to maintain precise and current records concerning all requests and/or disclosures of medical record information that can be quickly accessed anywhere in the provider network. The cost of setting up an internal network to keep track of such information could be prohibitively expensive, particularly in the case of large, nationwide integrated delivery networks (“IDNs”). On the other hand, small clinics, particularly in poorer areas, may lack the necessary resources to keep track of information in a manner that complies with HIPAA regulations, which are soon to be implemented.

In view of the foregoing, there is a tremendous need to find solutions to the tremendous tracking and accounting challenges soon to be imposed by HIPAA. In addition, there is an ongoing need in other industries to more carefully and accurately track the flow of sensitive, confidential or other information. It would be an improvement in the computer art to design methods and systems that would obviate the need for each individual provider to implement its own internal tracking and accounting system in order to comply with HIPAA, or otherwise improve its ability to accurately and currently track the flow of record information. Methods and systems that address these and other problems are disclosed and claimed herein.

### SUMMARY

The present disclosure relates to methods and systems useful in tracking disclosures of record information and then providing accountings of such disclosures. The disclosed methods and systems have particular application in the field of medical record and record information disclosures, particularly in view of HIPAA requirements. Nevertheless, the methods and systems may generally be used to track and account for disclosures of any type of record information.

The processes and systems according to the invention are advantageously implemented using a plurality of computers that communicate together, typically a computer network or system. The main component is a data processing center that is configured so as to (1) receive requests for the disclosure of record information by providers in possession of such information, (2) receive verification information from providers relating to the disclosure of record information, and (3) provide access to stored verification information to allow for accountings of disclosure in response to accounting requests.

The data processing center advantageously communicates with the requestors and providers by secure electronic connections, such as secure websites involving the Internet or other communications means disclosed herein. The data processing center may advantageously host provider-specific web sites that can be used to enter request data and/or verification information. Such provider-specific web sites may include logos, trademarks, or other unique features that identify the web site with a particular provider.

In an exemplary process, a requestor generates a request for a disclosure of record information pertaining to a patient or client of a provider in possession of the record information. The request is sent to the data processing center, either directly by the requestor or indirectly via the provider. The data processing center stores and associates the request with the corresponding patient and provider. The request is sent or made available to the provider, thus prompting the provider to take steps necessary to find and disclose the requested information.

In connection with a disclosure of record information, the data processing center receives from the provider verification information relating to the disclosure that is generally necessary to later provide an accounting of disclosure. In some cases, record information may be disclosed without a formal request, such as where the government mandates the release of certain record information in which the government has a legal interest or right to obtain such information.

A patient or other authorized party may thereafter request an accounting of disclosure, typically by contacting the provider or data processing center. Upon receipt of an accounting request, the provider or data processing center accesses verification information relating to any release of record information by the provider relating to the patient requesting the accounting of disclosure. In this way, the methods and systems according to the invention provide an efficient mechanism for tracking the disclosure of record information and the subsequent accounting of such disclosures.

These and other features of the invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a diagram schematically illustrating an exemplary process for tracking disclosures of record information according to the invention;

FIG. 2 is a schematic diagram illustrating an exemplary system or network for tracking disclosures of record information including the Internet infrastructure as part of the system or network according to the invention;

FIG. 3 is a flow diagram depicting an exemplary process for requesting and disclosing record information and then accounting for disclosures;

FIG. 4 is a flow diagram depicting an exemplary subprocess for generating, sending and storing a request for disclosure of record information by a data processing center;

FIG. 5 is a flow diagram depicting an exemplary subprocess for verifying record disclosure information by a data processing center;

FIG. 6 is a flow diagram depicting an exemplary subprocess for requesting and obtaining an accounting of disclosure of release of record information;

FIG. 7 is a flow diagram depicting an exemplary subprocess for sending medical record information to an authorized party; and

FIG. 8 illustrates an exemplary computer system that provides a suitable operating environment for carrying out the present invention.

### DETAILED DESCRIPTION OF THE INVENTION

I. Introduction and Definitions.

The present invention relates to processes and systems for tracking the release of medical record information, as well as software for implementing these processes. Such processes and systems greatly streamline the ability of a provider to provide accountings of disclosure of medical record information for each of its patients. The process and systems according to the invention are advantageously implemented using computers which communicate together, typically a computer network or system. Internal communication may be by a direct electronic link, by the Internet, or a combination thereof, as may be the communication between the data processing center with outside parties. The processes and systems may track the disclosure of information in a manner that advantageously complies with HIPAA reporting regulations. Nevertheless, the inventive processes and systems are not limited to tracking medical record disclosures but may be used in more effectively tracking the flow of record information in any desired context.

The term “data processing center” shall refer to a computer system that facilitates one or more of (i) receiving and processing requests for release of record information; (ii) communicating the requests to one or more providers; (iii) receiving verification information from the providers to ensure compliance with appropriate protocols; and (iv) facilitating or providing accountings of disclosure of released record information to authorized parties. The data processing center may be located at a single location or it may constitute a system of computers at different locations that are networked together. The data processing center may serve the interests of multiple parties, or it may be owned and operated exclusively for the benefit of a single party (e.g., a nationwide IDN for tracking transactions by many different providers within the IDN network). While preferably computerized and automated as much as possible, the functions carried out by the data processing center may require some human intervention (e.g., when information is received orally or in non-electronic tangible form).

The term “requestor” shall refer to any party that is making a request for record information from a custodian of such information, either directly or to the data processing center as intermediary. Examples of typical requestors of medical records include life insurers, property and casualty insurers, worker's compensation insurers, long term care insurers, personal injury and defense attorneys, health care providers, document copy services, providers of Internet services to insurers and attorneys, government agencies, and the patients themselves or their legal guardians, heirs or other related parties. There is, however, no restriction as to who may constitute a “requestor”. Requestors may request records other than medical records or information contained therein. The requestor may be the party actually making the request, or an employee, agent, or affiliate of the requesting party.

The term “provider” shall refer to any individual or entity that is a past or present custodian of record information relating to a client, patient, transaction, and the like. Examples of medical providers that may be subject to HIPAA regulations include hospitals, IDNs, medical clinics, laboratory information systems, independent laboratories, health insurance plans, home health care providers, pharmacies, health care clearing houses, doctors, nurses, doctor's assistants, and employees, agents, and affiliates of these individuals or entities. Examples of agents and affiliates include document repositories, copy centers, runners, communications centers and the like. The term “providers” also includes other custodians of documents, such as governmental agencies, businesses, libraries, non-profit organizations, museums and the like.

The term “access to”, in the context of a provider having “access” to a medical record, shall refer to any situation in which a provider has or may obtain access to a given record or information contained in the record. Access may be actual or prospective.

The term “record” shall refer to one or more documents, whether in tangible or digital form, including hand written or typed records, such as hand written or typed medical records. Hence, the term “requested record” may include more than one physical document and/or more than one type or category of record.

The term “record information” shall refer to the records themselves and also summaries or digests of such records, including, but not limited to, oral, tangible or electronic summaries, digests or representations of or concerning such records.

The term “request data” shall refer to all or part of the information contained in a request for disclosure of record information. It may optionally comprise text or graphic information contained in request forms used to input specific data needed to identify record information that is the subject of the request.

The term “verification information” shall refer to all or part of the information sent by a provider to the data processing center relating to a release of record information, whether or not in response to a formal request. In the case of a request, the verification information may contain any portion of the request data and any additional information as required to comply with a predetermined protocol for verifying and tracking disclosures of record information. In the case where information is released without a request (e.g., required disclosures to governmental agencies), the verification information may contain the sum total of all information relating to a release of record information.

The term “accounting of disclosure” shall refer to any summary, disclosure report or representation of any disclosure of record information, whether oral or in written form, whether or not it complies with the request, internal provider policy, governmental regulation, or other predetermined protocol. It may also comprise confirmation that no disclosure of record information was made in a particular instance.

The term “accounting request” shall refer to all or part of the information contained in a request for an accounting of disclosure.

II. Operating System.

A. General Environment.

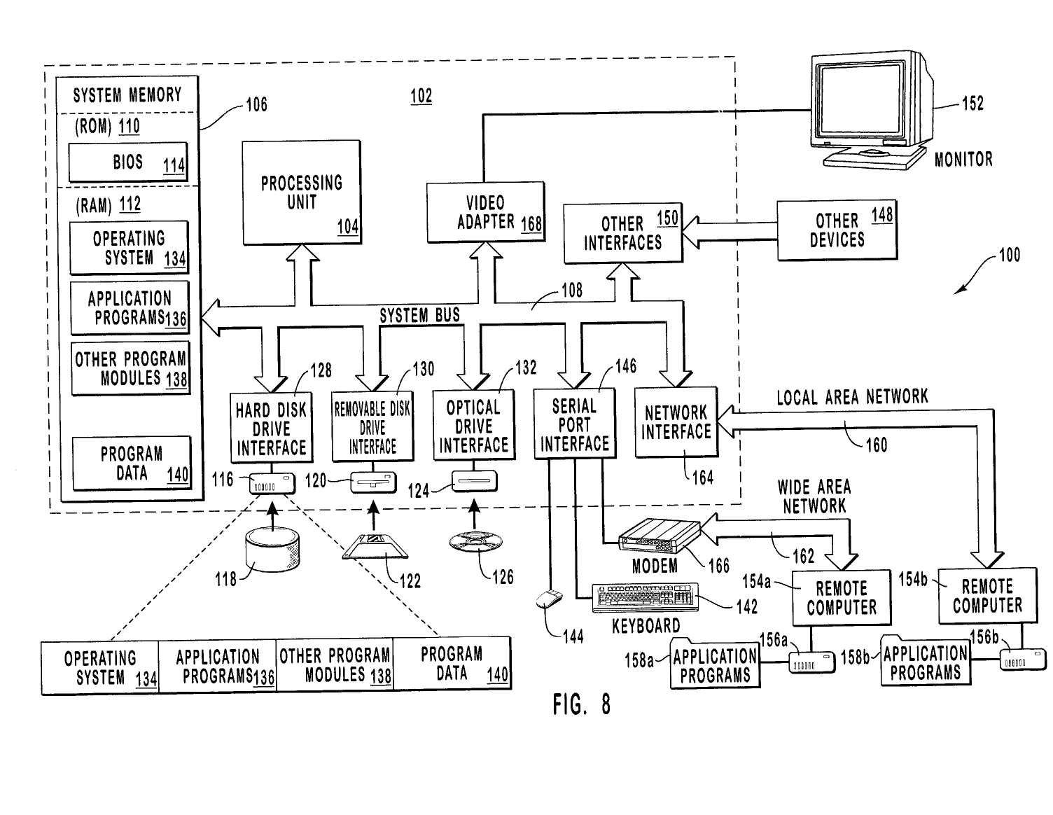

The inventive methods may be carried out using any system suitable for receiving requests for the release of record information, storing verification information relating to the disclosure of record information in response to such requests some other regulation, and accounting for the disclosure of record information. In general, and by way of background, the embodiments of the present invention may comprise or be implemented, at least in part, using special purpose or general purpose computers including various computer hardware, as discussed in greater detail below with respect to FIG. 8.

Embodiments within the scope of the present invention may include computer-readable media for carrying or having computer-executable instructions or data structures stored thereon. Such computer-readable media can be any available media that can be accessed by a general purpose or special purpose computer. By way of example, and not limitation, such computer-readable media may include random access memory (RAM), read only memory (ROM), electrically erasable programmable read only memory (EEPROM), compact disc read only memory (CD-ROM), digital video disc (DVD), or other optical disk storage, magnetic disk storage or other magnetic storage devices, or any other medium which can be used to carry or store desired program codes in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium, as would be any medium for transmitting a propagated signal. Combinations of the above should also be included within the scope of computer-readable media. In addition to computer-readable media, computer-executable instructions or data structures may be partly or wholly provided to or sent from a computer in the form of a propagated wave, typically by means of one or more communications connections between two or more computers. Computer-executable instructions comprise, for example, instructions and data which cause a general purpose computer, special purpose computer, or special purpose processing device to perform a certain function or group of functions.

B. The Data Processing Center.

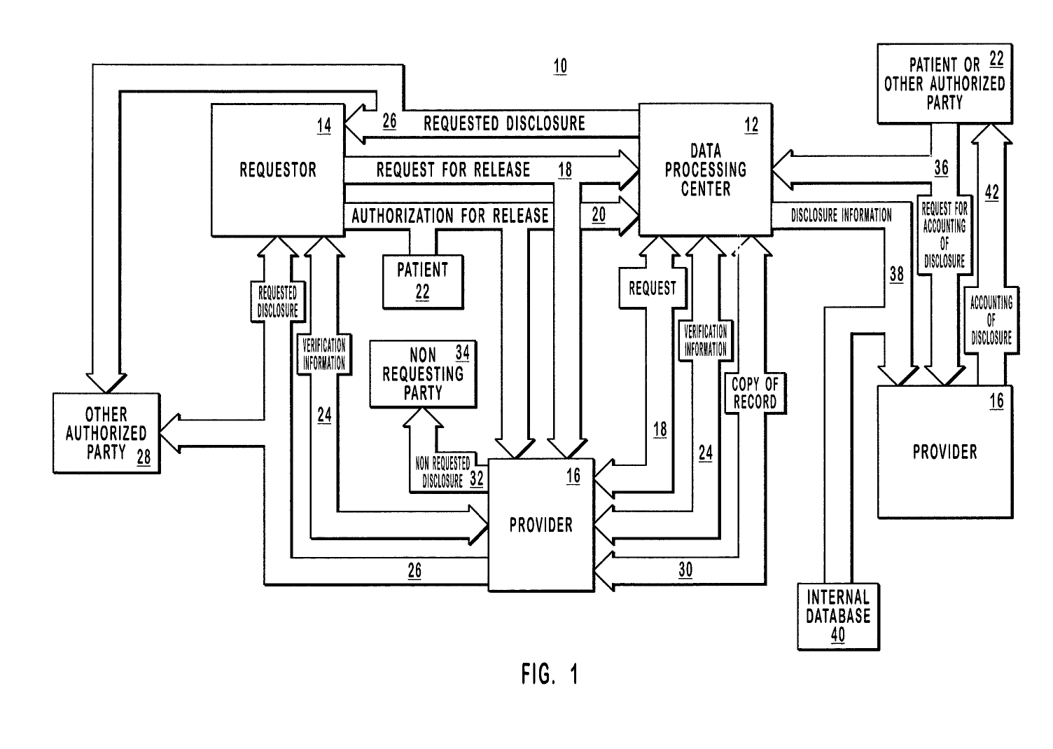

The computerized systems according to the invention for processing requests for the disclosure of record information, processing verification information relating to a disclosure of record information by a provider, and providing accountings of disclosures of record information are generally controlled or directed by a data processing center in communication with any requestors of medical records and providers of services that generate the relevant records or record information. The centralized function or role of the data processing center to carry out the inventive transactions according to the invention is illustrated in FIG. 1.

FIG. 1 schematically depicts an exemplary system 10 for carrying out various process steps described herein. The exemplary system 10 for processing requests for record disclosures and verifications of record disclosures and providing accountings of such disclosures includes, as its main information and control hub, a data processing center 12. The data processing center 12 is substantially or wholly automated by means of one or more computer systems that are able to receive and analyze information, make decisions, store and associate data, and send information as needed to carry out the inventive processes disclosed herein. The data processing center 12 generally communicates electronically with one or more requestors 14 and one or more providers 16. The data processing center 12 may include any hardware and software that facilitate the processes described or suggested herein. It may also involve human intervention to carry out one or more of the described tasks.

In one scenario, a disclosure of record information occurs in response to a specific request that is generated by a requestor 14. In this case, a requestor 14 generates a request 18 for the release of record information from a provider 16, typically as it relates to a patient 22 or other client of the provider 16. In the case of medical records, the request 18 may be accompanied by an authorization 20 for the release of record information signed by a patient 22. As will be discussed more fully below, the request 18 may be sent or communicated to either the data processing center 12 directly, or indirectly via the provider 16. The request 18 may be in electronic, tangible or verbal form. At some point the request 18 will be stored by the data processing center 12 in electronic form and associated with the patient 22 and provider 16. If an authorization 20 is required, it may be sent to the data processing center 12 together with the request 18, or it may be kept for the sole use and information of the provider 16.

In an alternative scenario, a disclosure of record information may occur independent of a formal request (e.g., as a result of government reporting requirements). Methods and systems according to the invention may be structured to handle one or both of the foregoing alternatives that prompt the disclosure of record information.

To facilitate tracking and subsequent accounting of disclosed information, the data processing center 12 receives verification information 24 from the provider 16 relating to the disclosed information. The data processing center 12 stores and associates the verification information 24 with the patient 22 and provider 16 for later retrieval. The verification information 24 generally comprises whatever information is required to later provide an accounting of disclosure of the disclosed information.

The requested disclosure 26 may be sent to the requestor 14 and/or other in authorized party 28 in any desired form (e.g., as a copy, digest or summary of the record, tangible, digital or oral form). It may be sent by the provider 16 and/or the data processing center 12 depending on the nature of the requested disclosure 26, the request 18, and/or the relationship between the various parties. The data processing center 12 may optionally receive a copy of the record 30 forming the basis of the disclosure, which it may simply forward to the requestor 14 or other authorized party 28, or which it may first convert to electronic form and optionally encrypt.

In the case of a non requested disclosure 32, which may be tangible, electronic or oral, the information will typically be communicated from the provider 16 to the non requesting party 34 according to pre-existing guidelines or regulations. It will normally not involve a formal request received by the data processing center 12. In most cases, verification information 24 is merely received by the data processing center from the provider 16, stored and associated with the patient 22 and provider 16 for later retrieval.

The verification information 24 stored within the data processing center 12 and associated with each patient 22 and provider 16 facilitates later accountings of disclosure. A patient 22 or other authorized party makes a request for an accounting of disclosure (or accounting request) 36 to either the provider 16 or data processing center 12. Disclosure information 38 comprising all or part of the verification information 24 pertaining to the patient 22 and provider 16, and possibly other information generated subsequently, is accessed by or sent to the provider 16 from the data processing center 12. In the alternative, the disclosure information 38 may be obtained by the provider 16 from an internal database 40 that contains stored information given to the provider 16 by the data processing center 12 (e.g., as a copy on a recordable medium, such as a CD Rom, or secure download, such as using an application programming interface (“API”) connection). An accounting of disclosure 42 is then prepared and sent by the provider 16 to the patient 22 or other authorized party (e.g., a government agency or a family member or legal guardian of the patient 22).

In general, the data processing center 12 advantageously includes a processing system and associated software for receiving, storing and associating request data, verification information, and electronic copies of released documents with the relevant patient and provider. It may also include modules for converting a tangible copy of a document into electronic form and encrypting the electronic copy. The data processing center 12 includes storage means, such as one or more magnetic disks or tapes, volatile and nonvolatile memory devices, optical storage devices, and the like for storing and later retrieving data to facilitate carrying out the inventive processes described herein.

In order to provide the ability of the requestor 14 or provider 16 to check the status of the request 18, a status check module may be provided by the data processing center 12. The status check module may also allow the requestor 14 or provider 16 to determine if there is a problem or informality that might be causing delay in processing the request 18, such as a missing authorization 20, insufficient request information, or insufficient funding. Billing and payment modules may be provided to facilitate and track billing and payment transactions between the parties.

C. Inter-Party Communication.

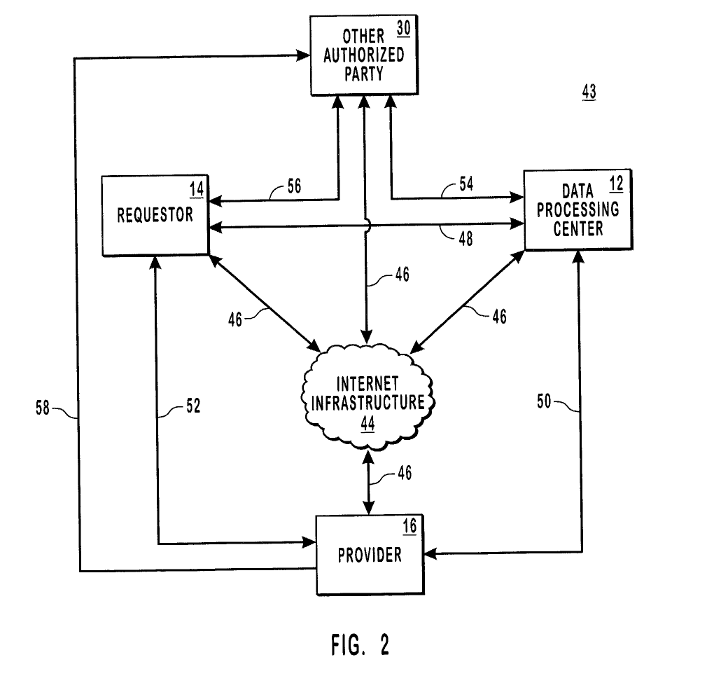

FIG. 1 provides a general illustration of the relationship between the data processing center 12, requestor 14, provider 16 and other parties. FIG. 2 provides a schematic illustration of a communication network 43 allowing the various parties to communicate with each other. As shown therein, at least some of the communications between the various parties may advantageously be carried out by means of the Internet, more particularly the Internet infrastructure 44. As shown therein, the communications network 43 includes the data processing center 12, requestor 14, provider 16, and other authorized party 30 linked together by various means, as needed, to carry out the methods described or suggested herein.

In one embodiment, the data processing center 12, requestor 14, provider 16 and other authorized party 30 communicate with each other by means of the Internet infrastructure 44, such as by means of Internet links 46. The Internet links 46 are advantageously provided with firewalls or other secure portals, as well as encryption hardware and software, to prevent unauthorized access to confidential or other sensitive information being shared between the parties. An example of a preferred Internet link is a secure HTTP Internet connection with 128-bit secure socket layer encryption.

In another embodiment, the parties may also communicate by means of direct communication linkages 48, 50, 52, 54, 56, 58 that do not involve the Internet infrastructure 44. Such direct linkages may include, for example, frame relays, dedicated lines, either through hard-wired phone lines or wireless communication pathways, including but not limited to phone, modems, T1, T3, DSL, ATM, OC3, OC12, DS12, DS48, and other lines, and cable data connections, fax machines, and devices for the manual or verbal sharing of information.

In a presently preferred embodiment, the communications subsystem linking the data processing center 12 and the requestor 12 includes an Internet connection 46. The Internet connection 46 between the requestor 14 and data processing center 12 may be in the nature of a dedicated website provided by the data processing center 12 for a particular provider. In this scenario, communications between the requestor 14 and data processing center 12 will typically be in the form of HTML documents. The provider 16 may likewise communicate with the data processing center 12 by means of a dedicated website that is specific to that provider and which will typically require a secure login procedure.

Alternatively, the requestor 14 and/or provider 16 may be electronically connected to the data processing center 12 by an API, which involves special software that integrates the existing software of the requestor 14 or provider 16 with the operating system of the data processing center 12. In the case of an API, each requestor 14 or provider 16 could conceivably use its own software when generating a request or providing verification information. The API then converts the request from whatever format is used by the requestor 14, or verification information from the provider 16, into a format that is compatible with the manner in which data is processed by the data processing center 12.

Similar connections between the data processing center and other third parties are within the scope of the invention. These include connections between the data processing center 12 and any other party that may be part of the transaction or process of providing and tracking a disclosure of record information.

III. Methods for Tracking and Accounting for Disclosure of Record Information.

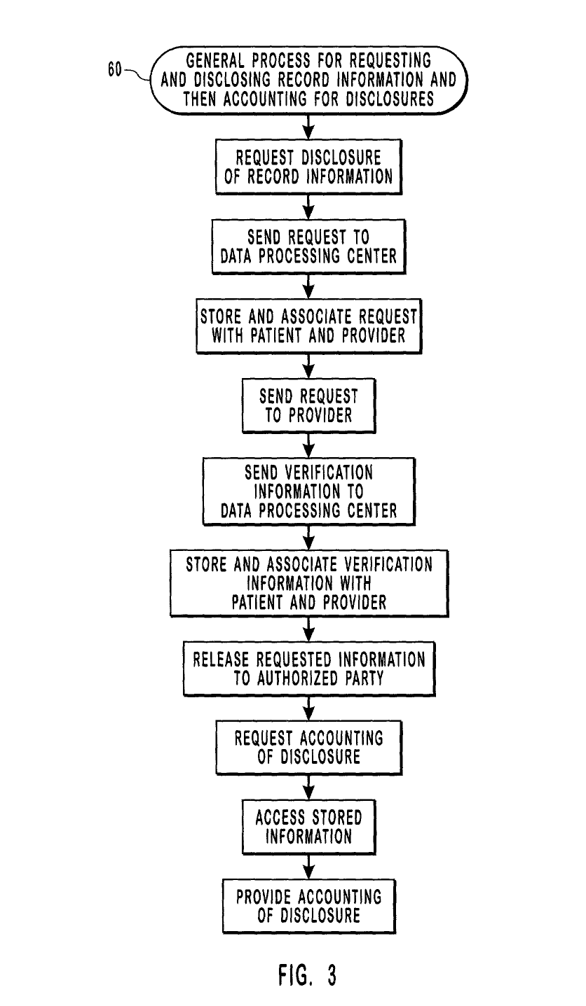

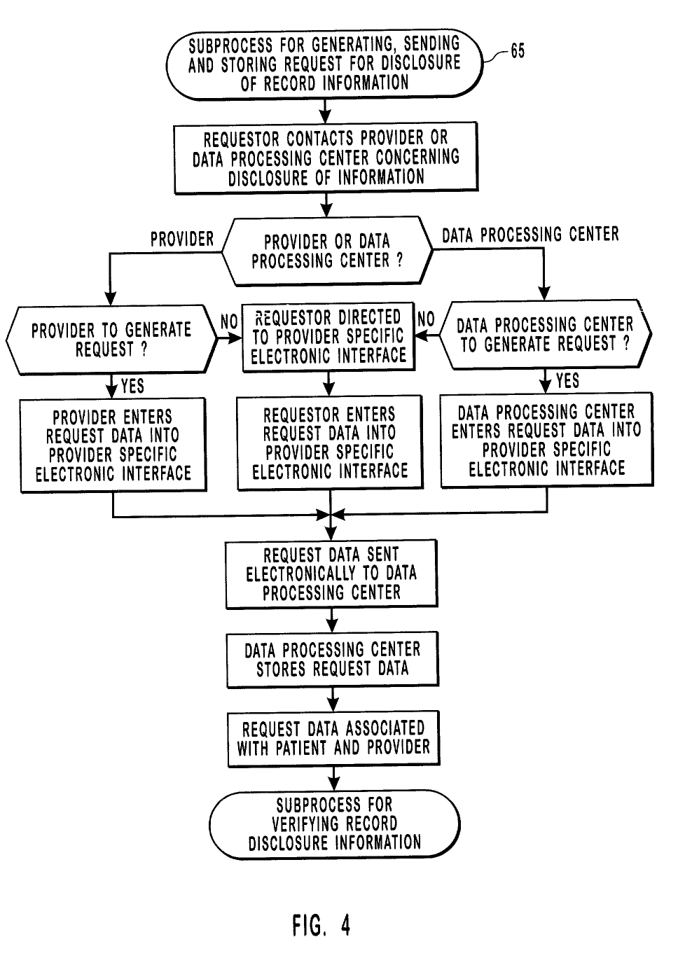

FIGS. 3-7 provide flow diagrams that illustrate exemplary processes for tracking and accounting for disclosures of record information. FIG. 3 and the accompanying discussion provide a general overview of an overall process that may include separate and patentably distinct subprocesses, at least some of which are more particularly illustrated in FIGS. 4-7 and the accompanying discussion.

General Process for Requesting and Disclosing Record Information and Then Accounting for Disclosures.

FIG. 3 is a flow diagram depicting an exemplary general process 60 for requesting and then disclosing record information and then accounting for disclosures. Initially, a requestor generates a request for a disclosure of record information for a particular patient or client of a provider. The request is sent to the data processing center, either directly or indirectly through the provider. The data processing center stores and associates the request with the corresponding patient and provider to which it pertains. The request is then sent, or otherwise made available, electronically by the data processing center to the provider that has been requested to provide a disclosure of record information.

After being notified of a request for the release of record information, or in the case where the provider makes a disclosure of record information in the absence of a request, the provider sends verification information to the data processing center relating to the disclosure. The verification information may simply consist of some or all of the data contained in the request, or it may include additional information that may be useful in later providing a full and complete accounting of disclosure. For example, the initial request may be incomplete such that the provider may ask the requestor or other knowledgeable party (e.g., a patient) to supply additional information required to complete the request. The verification information may include information known only to the provider, such as details relating to the records in question and specific facts relating to the actual release of record information (e.g., the date and content of the released information and the manner in which it was released). The verification information, whether received in a single transaction or in a number of different transactions, is stored by the data processing center and associated with the patient and provider.

At some point, whether before, during or after completion of the verification information by the provider and the storage of such information by the data processing center, the requested information is released to an authorized party. The authorized party may be the requestor, in the case where the release of information is in response to a request, or some other authorized party. In the alternative, the authorized party may be a non-requesting party, such as a government agency that periodically receives disclosures of record information according to specific prescribed rules and regulations (e.g., epidemiology reports and patient milestones).

The disclosed information may comprise a copy of a record, a portion or written summary thereof, or an oral summary of representation. It may be sent directly by the provider to the party authorized to receive it, or it may be sent, in whole or in part, by the data processing center. The data processing center may store an electronic copy of the disclosed record or information relating thereto. The stored record information may optionally be encrypted to protect its contents from unauthorized access.

Storage of verification information relating to each release of record information, whether in response to a release or a spontaneous disclosure of record information, allows for subsequent accountings of the disclosure of information. A request for an accounting of disclosure is typically made to the provider, although it could also be made to the data processing center. In the case of medical records, the request for accounting of disclosure will need to comply with HIPAA regulations. In a typical case, a patient will make or present the accounting request to the provider which provided medical services and which is the custodian of medical records relating to the medical services rendered.

The provider (or data processing center) then accesses stored information, typically the aforementioned verification information, relating to any disclosures of information contained in medical records of the patient for services rendered by the provider. In one embodiment, the stored information is located within the data processing center. In this case, the provider (or data processing center) generally logs on, enters the appropriate information in order to obtain the necessary information relating to the disclosures, and then retrieves the necessary information from storage in the data processing center. In the alternative, the provider may possess a copy of the stored information, such as where the data processing center gives the provider a copy of stored information pertaining to the provider. This allows the provider to access its own database of information necessary to provide an accounting of disclosure. Once the relevant information has been accessed, the provider gives an accounting of disclosure to the requesting party. In the alternative, the data processing center may be equipped to render accountings of disclosure when asked.

B. Subprocess for Generating, Sending and Storing Requests for Disclosure of Record Information.

FIG. 4 is a flow diagram depicting an exemplary subprocess 65 for generating, sending, and storing a request for disclosure of record information. In the typical scenario, a requestor first contacts a provider concerning the disclosure of requested information. This initial contact by the requestor to the provider may be in the form of a telephone call, a letter, a facsimile, e-mail, walk-in visit or other inquiry. The provider may decide to fill out the request form itself or it may instead direct the requestor to a provider-specific electronic interface, such as a web page provided by the data processing center for receiving requests for disclosure on behalf of the particular provider in question. The provider may also direct the requestor to submit the request in one of a variety of methods for manual entry by an employee of the data processing center. In the case where the provider enters the information, it will typically be input in a provider-specific electronic interface provided by the data processing center, which may be the same or a similar interface to the one used by the requestor. In one embodiment, the provider-specific electronic interface may comprise a web page (e.g., hosted by the data processing center).

The provider-specific web page will typically include one or more fields for inputting specific types of request data, such as information relating to the requestor, the patient or other party to whom the record documents pertained, billing information, and the identity or nature of the record information to be disclosed. The provider-specific web page may include origin information associating that particular web site with a particular provider, such as text, graphic or logo information specific to the provider. This provides the requestor with confirmation that the correct web page has been accessed from among a plurality of web pages pertaining to some or all of the providers that have a relationship with a data processing center.

After a request for disclosure has been received and stored by the data processing center, it is associated with the patient and provider to which it pertains and then made available to the provider. The data processing center may actively send the request data to the provider, or notify the provider that the request data exists and needs to be accessed. Alternatively, the data processing center may simply store the request data in a manner that can be readily accessed by the provider upon active inquiry by the provider. For example, the provider may periodically check by logging onto a secure electronic interface with a data processing center in order to determine whether any new requests for disclosure of record information have been made. The data processing center may advantageously provide confirmation reports, status updates, ticklers and other information that allows the requestor, provider or both to monitor the status of a particular request.

Where a number of requests are generated for a particular provider, the data processing center, provider, or both may sort the requests in order to prioritize them according to a predetermined algorithm, (e.g., date of request, type of information requested, patient status, identity of requestor, etc.). Requests may be rerouted from one branch to another of a provider.

C. Subprocess for Verifying Record Disclosure Information.

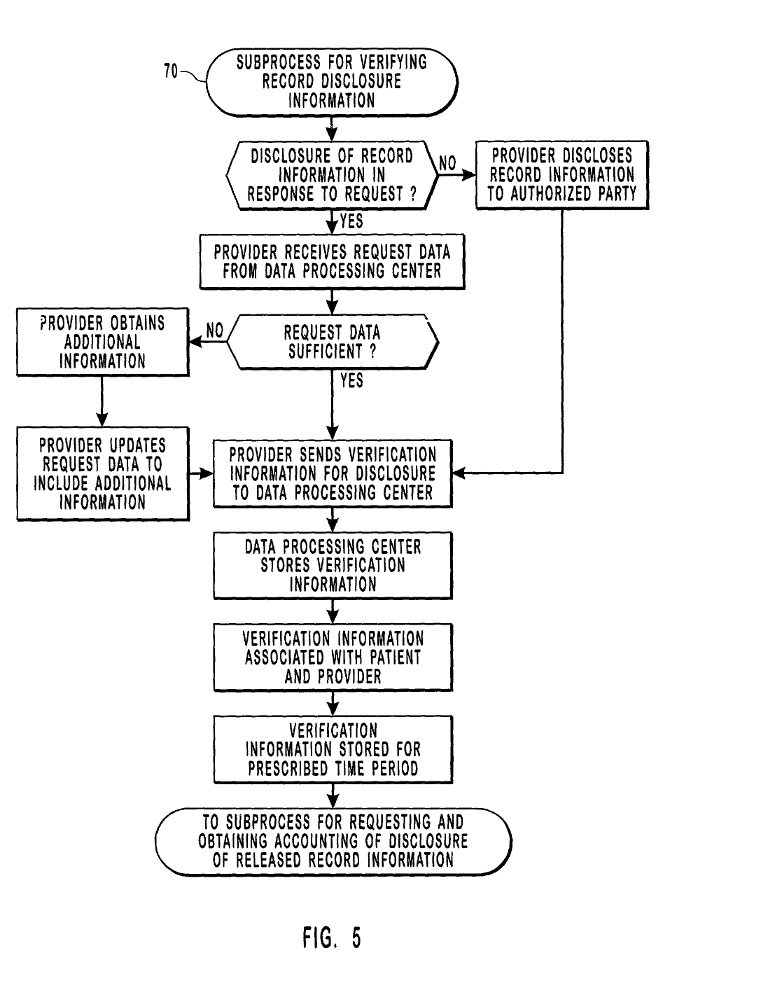

FIG. 5 is a flow diagram depicting an exemplary process 70 for verifying record disclosure information. The term “verification information” broadly includes all information necessary to track a particular request for disclosure and any information required to later provide an accounting of the disclosure. The provider generally sends the data processing center verification information, typically in electronic form, regardless of whether a disclosure of record information is in response to a specific request or whether it was provided spontaneously, such as by government decree or regulation.

In the case where a disclosure of record information is prompted by a request, the request may be generated and sent to the data processing center as described above with respect to FIG. 4. The “request” may be in the form of an internal audit by the provider indicating that record information should be disclosed to an authorized party or government entity.

As stated above, the data processing center sends the request data, or otherwise makes it available, to the provider. The provider then checks the request data to determine whether it is sufficient or complete or whether additional information is required. If the request data is complete, the provider confirms this fact by sending a report in electronic form to the data processing center. In the event that it is not complete, the provider obtains additional information, such as from the provider or patient, in order to complete the request. In addition, the provider may update the request data to include additional information known only to itself, such as the specific document or record information released (e.g., doctor's notes, test results, diagnostics, reports, summaries, etc.), how the record information was released (i.e., in what form), date of release, to whom it was released, and the dates of service. The provider sends the verification information relating to the disclosure of record information to the data processing center, either in a single batch or in multiple batches.

In the alternative, in the case where the disclosure of record information is not in response to a request, the provider simply discloses the record information to the party authorized to receive it (e.g., birth certificate, date of birth, size, gender, etc.). Before or after this disclosure, the provider sends verification information of the disclosure to the data processing center. Because there is no request data, the provider typically generates all the verification information and sends it to the data processing center in the case where record information is disclosed in the absence of a request.

The data processing center receives and then stores the verification information, which it associates with the patient and provider to which it pertains. In the case where the disclosure of record information is in response to a request, the data processing center may add the verification information to the request data previously stored and associated with the patient and provider. In the case where a disclosure of record information is not in response to a request, the verification information is simply associated with the patient and provider in the first instance. In order to facilitate accountings of disclosure, the verification information is stored within the data processing center for a prescribed time period. In the alternative, or in addition to storing the information in the data processing center, the data processing center may give to a provider a separate database containing verification information relating to all disclosures of record information by the provider relative to its patients or other clients.

D. Subprocess for Requesting and Obtaining an Accounting of Disclosure of Release of Record Information.

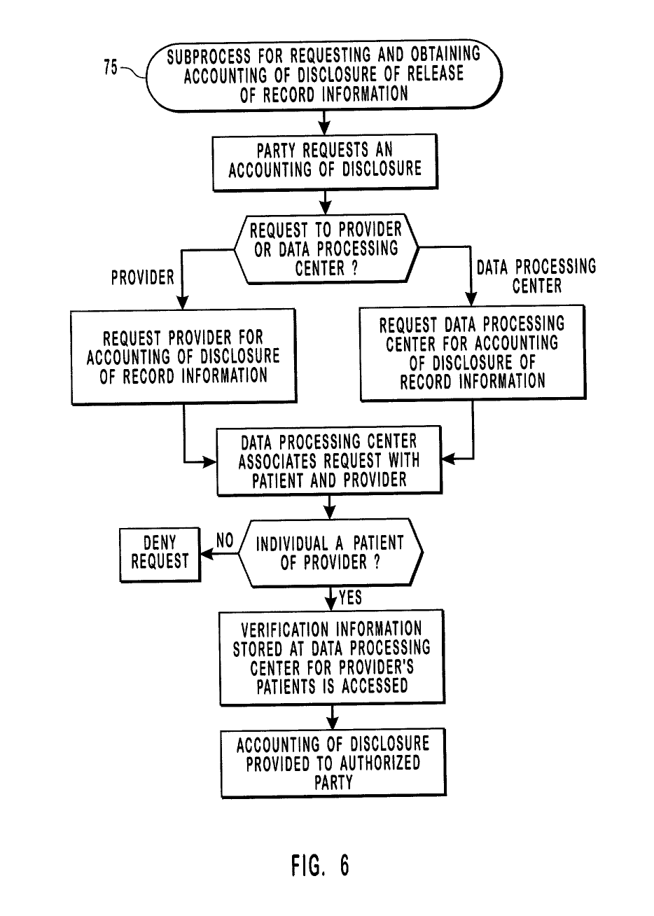

FIG. 6 is a flow diagram depicting an exemplary subprocess 75 for requesting and obtaining an accounting of disclosure relating to a release of record information. The request for an accounting of disclosure (or accounting request) is typically made by a patient or other party to whom the records pertain. Government agencies and other authorized party may also make requests for accountings of disclosure. The request for an accounting of disclosure is typically made to the provider. Nevertheless, it is certainly within the scope of the invention for the data processing center to respond to requests for accountings of disclosure.

If the provider is requested directly, the first step is to determine whether the requested disclosure relates to an actual patient of the provider. If not, and the request for accounting is in error, the request may be denied or rerouted if possible. If the request does, in fact, pertain to a patient or other client of the provider, the provider then accesses verification information stored at the data processing center. In the alternative, it may access its own internal database of verification information in its possession. The accounting request is sent to the data processing center, stored and associated with the patient or other client to which it pertains. At some point, the provider provides the requested accounting of disclosure to the party authorized to receive the accounting.

In the alternative, the data processing center may itself generate accountings of disclosure. In this case, it receives the accounting request and then stores and associates the accounting request with the patient and provider. As before, if the patient is not a client of the provider, the request is denied or else the party requesting the accounting is asked to correct the request if there is an error. In most cases, the data processing center will simply access its own internal database to obtain verification information relating to the patient. However, it is conceivable that it may also access verification information in the possession of the provider, particularly in the case where a provider may periodically update its own database and be in possession of the most current data.

The accounting of disclosure may report whether a particular record or disclosure of information contained therein was made at all, when, to whom, why, and the nature of the disclosure. In the case of medical records, the nature of the information accessed and the accounting of disclosure will preferably comply with HIPAA regulations. In this way, the systems and methods disclosed herein provide a way to quickly provide accountings of disclosure in compliance with HIPAA regulations as requested.

The centralized nature of stored information relating to the release of record information by a provider of one of its patients facilitates the ability of one branch of a provider to generate an accounting of disclosure related to any branch of the provider. In the alternative, the data processing center provides for easy rerouting of the accounting request to the correct branch that released the information. In turn, the data processing center can forward an accounting of disclosure from one branch to the branch where the accounting was requested.

E. Subprocess for Sending Record Information to an Authorized Party.

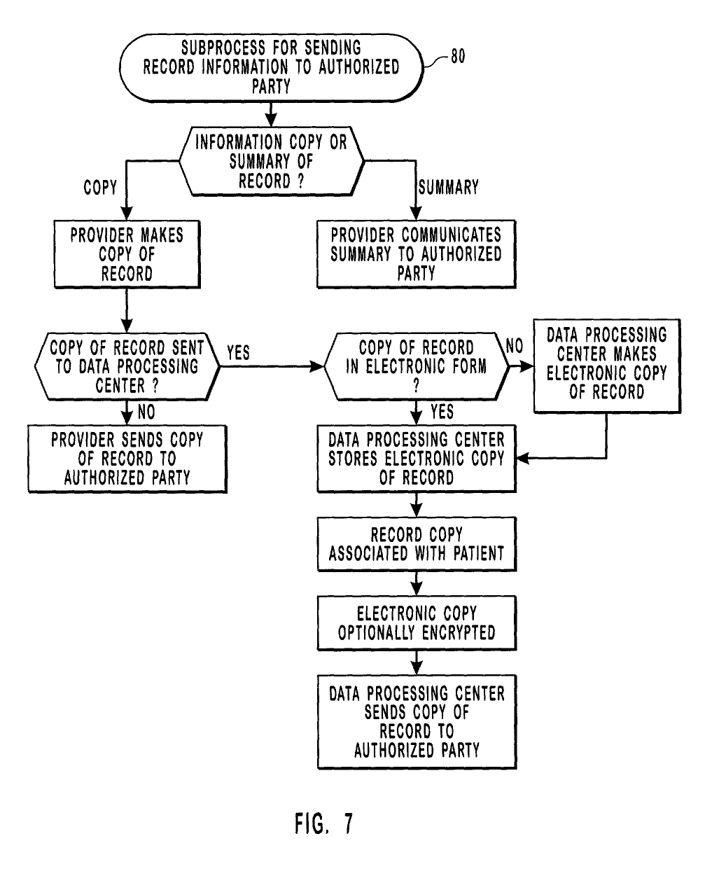

FIG. 7 is a flow diagram depicting an exemplary subprocess 80 for sending record information to an authorized party. In some cases, the requested record information will simply be a copy of the record. In other cases, it may comprise a portion or summary of the record.

In the case of a copy of a record, the provider makes a copy and sends it to the party authorized to receive it. In some cases, it may send a copy of the record to the data processing center, either in tangible or electronic form. If in tangible form, the data processing center typically makes an electronic copy of the record and then stores the copy in its internal database. The record copy is then associated with the patient and provider to which it pertains. The data processing center may encrypt the electronic copy of the document in order to protect the information contained therein. The data processing center may send a tangible or electronic copy of the record to the authorized party, or it may send a summary.

In the case where the record information that is released is in the form of a summary, it may be sent to the authorized party in the absence of making and sending a copy of the underlying record. The summary may be provided in either tangible or oral for depending on the nature of the disclosure.

F. Other Processes.

Although not depicted in the flow diagram, there may be other processes relating to the foregoing processes described above. For example, the data processing center may generate a bill that is sent to either the requestor, the provider or both depending on the nature of the transaction. The data processing center may also collect money from providers and requestors according to the relationship with the various parties. One of ordinary skill in the art will be able to create an appropriate billing system for the given situation.

IV. Detailed Description of Exemplary Operating System.

FIG. 8 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc., that perform particular tasks or implement particular abstract data types. Computer-executable instructions, associated data structures, and program modules represent examples of the program-code means for executing steps of the methods disclosed herein. The particular sequences of such executable instructions or associated data structures represent examples of corresponding acts for implementing the functions described in such steps.

Those skilled in the art will appreciate that the invention may be practiced in network computing environments with many types of computer system configurations, including personal computers (PCs), hand-held devices, multi-processor systems, microprocessor-based or programmable consumer electronics, networked PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 8, an exemplary system for implementing the invention includes a general purpose computing device in the form of a conventional computer system 100, which, in its broadest sense, includes components hardwired or otherwise associated together within a conventional computer box, bundle, or subsystem illustrated by item number 102, together with user interface, communications, and other devices and features located externally to, physically separated from, or otherwise spaced apart relative to the computer bundle or subsystem 102. By way of example, and not limitation, a conventional computer bundle or subsystem 102 includes a processing unit 104, a system memory 106, and a system bus 108 that couples various system components including the system memory 106 to the processing unit 104. The system bus 108 may be any of several types of bus structures including a memory bus or memory controller, a peripheral bus, and a local bus using any of a variety of bus architectures. The system memory includes read only memory (ROM) 110 and random access memory (RAM) 112. A basic input/output system (BIOS) 114, containing the basic routines that help transfer information between elements within the computer system 100, such as during start-up, may be stored in ROM 110.

The computer system 100, typically the computer bundle or subsystem 102, may also include a magnetic hard disk drive 116 for reading from and writing to a magnetic hard disk 118, a magnetic disk drive 120 for reading from or writing to a removable magnetic storage device 122, and an optical disk drive 124 for reading from or writing to a removable optical disk 126 such as a CD-ROM, digital versatile disk, a laser disk, or other optical media. The magnetic hard disk drive 26, magnetic disk drive 120, and optical disk drive 124 are connected to the system bus 108 by a hard disk drive interface 128, a magnetic disk drive-interface 130, and an optical drive interface 132, respectively. The drives and their associated computer-readable media provide nonvolatile storage of computer-executable instructions, data structures, program modules, and other data for the computer 100. Although the exemplary environment described herein employs a magnetic hard disk 118, a removable magnetic disk 122, and a removable optical disk 126, other types of computer readable media for storing data can be used, including magnetic cassettes, flash memory cards, Bernoulli cartridges, RAMs, ROMs, and the like, as well as media that carry propogated signals. For purposes of the specification and the appended claims, the term “computer readable medium” may either include one or a plurality of computer readable media, working alone or independently, so long as they singly or collectively form part of a recognizable system for carrying out the processes of the invention.

Program code comprising one or more program modules may be stored on the hard disk 118, magnetic disk 122, optical disk 126, ROM 110, or RAM 112, including an operating system 134, one or more application programs 136, other program modules 138, and program data 140. A user may enter commands and information into the computer bundle or subsystem 102 by means of a keyboard 142, a pointing device (e.g., “mouse”) 144, or other input devices, such as a microphone, joy stick, game pad, satellite dish, scanner, audio player, video player, camera, or the like. These and other input devices are often connected to the processing unit 104 through a serial port interface 146 coupled to the system bus 108. Alternatively, these and other devices 148 may be connected by other interfaces 150, such as a parallel port, a sound adaptor, an ATAPI port, a decoder, a game port or a universal serial bus (USB). Nonexhaustive examples of “other devices” 148 include scanners, bar code readers, external volatile and nonvolatile memory or storage devices, audio devices, video devices, and microphones. A monitor 152 or another display device is also connected to the system bus 108 via an interface, such as a video adapter 168. In addition to the monitor 152, computers typically include other output devices (generally depicted as “other devices” 148″), such as speakers and printers.

The computer system 100 may operate in or involve a networked environment using logical connections to one or more remote computers, such as remote computers 154a and 154b. Remote computers 154a and 154b may each be another personal computer, a server, a router, a network PC, a peer device or other common network node, and typically include many or all of the elements described above relative to the computer system 100, although only memory storage devices 156a and 156b and their associated application programs 158a and 158b have been illustrated in FIG. 8. The logical connections depicted in FIG. 8 include a local area network (LAN) 160 and a wide area network (WAN) 162 that are presented here by way of example and not limitation. Such networking environments are commonplace in office-wide or enterprise-wide computer networks, intranets, and the global computer network or “Internet”.

When used in a LAN networking environment, the computer bundle or subsystem 102 is connected to the local network 160 through a network interface or adapter 164. When used in a WAN networking environment, the computer bundle or subsystem 102 may include a modem 146, a wireless link, or other means for establishing communications over the wide area network 142, such as the Internet. The modem 146, which may be internal or external, is typically connected to the system bus 108 via the serial port interface 146. In a networked environment, program modules depicted relative to the computer bundle or subsystem 102, or portions thereof, may be stored in a remote memory storage device (e.g., remote storage devices 156a and 156b). It will be appreciated that the network connections shown are exemplary, and other means of establishing communications over wide area network 162 may be used.

Although computer components are commonly arranged in the form depicted in FIG. 8, with some components of the computer system 100 physically located within, and other components physically located outside, the computer bundle or subsystem 102, it will readily be appreciated that the terms “computer” and “computer system” should be broadly understood to include any or all of the foregoing components in any desired configuration which facilitate carrying out the inventive methods and systems disclosed herein. The terms “computer” and “computer system” may therefore include other common features or components not depicted in FIG. 8.

In addition to the foregoing computer system, the inventive networks may include components such as fax machines, scanners, printers, copy machines and any other device or component that may be necessary to facilitate the retrieval and copying of the requested medical records. One level of human intervention may also be necessary to process or carry out certain steps such as entering into a transaction between the requestor and the person authorizing the release of the medical records, signing of the authorization form by the client or other authorized person, one or more agents of the provider who receives and processes the request for the medical record, and the person who ultimately reviews the medical record to determine whether the transaction dependant on the medical record should go forward. To help ensure compliance, one or more calling centers in communication with the data processing center may be assigned the task of initiating a personal communication, such as a telephone call, with a representative of the provider that has access to the requested medical record. In short, the exemplary descriptions of computer systems and other hardware are given by way of example, not by limitation.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a data processing center, included in a system that also comprises a plurality of providers that generate or have access to record information, a method for tracking disclosures of such record information comprising:
providing a plurality of electronic interfaces configured to receive input of data relating to disclosures of record information, each electronic interface being provider specific so that data input into a particular electronic interface is automatically associated with a corresponding provider;
receiving, through an electronic interface, verification data relating to a disclosure by a specific provider of record information of an individual;
storing the verification information in a manner so as to associate it with the individual and the specific provider;
receiving a request for accounting of disclosure of record information of a particular individual by a particular provider;
associating the request for accounting of disclosure with stored data, if any, pertaining to any disclosure of record information of the particular individual by the particular provider; and
providing to an authorized party information relating to the request for accounting of disclosure.

2. A method as recited in claim 1, the data processing center comprising one or more computers and receiving and sending data by means of secure electronic connections.

3. A method as recited in claim 2, the secure electronic connections comprising at least one of a secure HTTP Internet connection with 128-bit secure socket layer encryption, frame relay, dedicated phone line, T1 line, T3 line, DSL line, ATM, OC3, OC12, DS3, DS12, DS48, cable data connection, or other secure electronic connection between the data processing center and the plurality of providers.

4. A method as recited in claim 1, the method further comprising providing a plurality of electronic interfaces configured to receive input of data relating to requests for disclosure of record information, at least some of the electronic interfaces being provider specific so that data input into a particular electronic interface is automatically associated with a corresponding provider.

5. A method as recited in claim 4, the method further comprising:
receiving through an electronic interface request data relating to a request for disclosure of record information of an individual accessible by a specific provider;
storing the request data in a manner so as to associate it with the individual; and
sending at least a portion of the request data to the specific provider through an electronic interface.

6. A method as recited in claim 5, the data processing center sending at least a portion of the request data to one or more branches of the specific provider through an electronic interface.

7. A method as recited in claim 5, the data processing center sending a plurality of requests to the specific provider in a particular order based on at least one of order of priority, dates requests were received, names or other identifying information of the individuals who are the subject of the record information in the requests, names or other identifying information of the requesting parties, or other sortable data relating to the requests.

8. A method as recited in claim 5, the data processing center receiving and storing data from the specific provider relating to reassignment of the request data from one branch to another of the provider.

9. A method as recited in claim 4, the data center providing at least one of web pages or one or more software applications with user interfaces configured to receive the input of data relating to requests for disclosure of record information, each web page or software application containing origin information identifying it with an origin provider.

10. A method as recited in claim 9, the origin information comprising one or more logos, colors, formatting, text information, or other customization of the origin provider.

11. A method as recited in claim 4, the data processing center receiving electronic copies of disclosed records and associating them with requests for record information to which the disclosed records correspond.

12. A method as recited in claim 11, the data processing center storing the electronic copies and sending them to authorized parties.

13. A method as recited in claim 11, the data processing center performing an encryption process on the electronic copies in order to protect private information contained therein.

14. A method as recited in claim 4, the data processing center receiving authorizations for disclosure of record information and associating the authorizations with corresponding requests for disclosure of records.

15. A method as recited in claim 1, the data processing center sending at least a portion of the information relating to the request for accounting of disclosure to at least one of (i) the specific provider that disclosed the record information or (ii) a party that made an accounting disclosure request to the specific provider.

16. A method as recited in claim 1, the data processing center sending at least a portion of the information relating to the request for accounting of disclosure to a branch of the specific provider where the request for accounting of disclosure was made.

17. A method as recited in claim 1, the data processing center receiving and storing information from a provider specifying that a particular disclosure of record information not be subject to accountings of disclosure for a specified time period.

18. A method as recited in claim 17, the data processing center withholding accountings of disclosure for the particular disclosure of record information during the specified time period.

19. A method as recited in claim 1, the data processing center repeating the method for additional disclosures of record information.

20. A method as recited in claim 1, the data processing center deleting stored verification information after a prescribed period of time.

21. A method as recited in claim 1, the data processing center generating one or more billing charges corresponding to a particular disclosure of record information.

22. A method as recited in claim 21, the data processing center generating a unique billing charge for each specific category of record information disclosed.

23. A method as recited in claim 21, the data processing center sending one or more of the billing charges to the provider that made the particular disclosure of record information.

24. A method as recited in claim 21, the data processing center sending one or more of the billing charges to a requestor t hat requested the particular disclosure of record information.

25. A method as recited in claim 1, the data processing center receiving and sending data pertaining to disclosures of information relating to medical records of individuals.

26. A method as recited in claim 25, the data processing center providing the information relating to the request for accounting of disclosure in a manner that complies with HIPAA regulations.

27. A computer-readable medium having computer-executable instructions for performing the method recited in claim 1.

28. A computerized system comprising a data processing center having means for implementing the method recited in claim 1.

29. A computerized system comprising a data processing center that comprises one or more modules for carrying out each act recited in claim 1.

30. In a data processing center, included in a system that also comprises a plurality of providers that generate or have access to record information, a method for tracking disclosures of such record information comprising:
providing a plurality of electronic interfaces configured to receive input of data relating to requests for disclosure of record information, at least some of the electronic interfaces being provider specific so that data input into a particular electronic interface is automatically associated with a corresponding provider.
providing a plurality of electronic interfaces configured to receive input of data relating to disclosures of record information, each electronic interface being provider specific so that data input into a particular electronic interface is automatically associated with a corresponding provider;
receiving through an electronic interface request data relating to a request for disclosure of record information of an individual accessible by a specific provider;
storing the request data in a manner so as to associate it with the individual; and
sending at least a portion of the request data to the specific provider.
receiving, through an electronic interface, verification data relating to the disclosure of record information by the specific provider;
storing the verification information in a manner so as to associate it with the individual and the specific provider;
providing to each provider access to stored verification information pertaining to record information disclosed by that provider in order to facilitate accountings of any disclosures of record information by that provider.

31. A method as recited in claim 30, the data processing center providing secure access to the stored verification information by means of a secure electronic connection between the data processing center and the provider.

32. A method as recited in claim 30, the data center providing secure access to the stored verification information by giving a copy of the stored verification information to the provider.

33. A method as recited in claim 30, the data processing center generating at least some of the accountings of disclosure.

34. A method as recited in claim 30, at least some of the providers generating at least some of the accountings of disclosure.

35. A method as recited in claim 30, the record information pertaining to medical records of individuals.

36. A computer-readable medium having computer-executable instructions for performing the method recited in claim 30.

37. A computerized system comprising a data processing center that comprises one or more modules for carrying out each act recited in claim 30.

38. In a data processing center, included in a system that also comprises a plurality of providers that generate or have access to medical record information, a method for tracking disclosures of such medical record information comprising:
providing a plurality of electronic interfaces configured to receive input of data relating to requests for disclosure of medical record information, at least some of the electronic interfaces being provider specific so that data input into a particular electronic interface is automatically associated with a corresponding provider.
providing a plurality of electronic interfaces configured to receive input of data relating to disclosures of medical record information, each electronic interface being provider specific so that data input into a particular verification electronic interface is automatically associated with a corresponding provider;
receiving through an electronic interface request data relating to a request for disclosure of medical record information of an individual accessible by a specific provider;
storing the request data in a manner so as to associate it with the individual; and
sending at least a portion of the request data to the specific provider.
receiving, through an electronic interface, verification data relating to the disclosure of medical record information by the specific provider;
storing the verification information in a manner so as to associate it with the individual and the specific provider;
receiving a request for accounting of disclosure of medical record information of a particular individual by a particular provider;
associating the request for accounting of disclosure with stored data, if any, pertaining to any disclosure of medical record information of the particular individual by the particular provider; and
providing to an authorized party information relating to the request for accounting of disclosure.

39. A method as recited in claim 38, the data processing center generating at least some accountings of disclosure in compliance with HIPAA.

40. A method as recited in claim 38, at least some of the providers generating at least some accountings of disclosure in compliance with HIPAA.

41. A method as recited in claim 38, wherein at least some of the electronic interfaces configured to receive input of data relating to requests for disclosure of medical record information are also configured to receive input of data relating to disclosures of medical record information.

42. A method as recited in claim 38, wherein at least some of the electronic interfaces configured to receive input of data relating to requests for disclosure of medical record information are separate from the electronic interfaces configured to receive input of data relating to disclosures of medical record information.

43. A computer-readable medium having computer-executable instructions for performing the method recited in claim 38.

44. A computerized system comprising a data processing center that comprises one or more modules for carrying out each act recited in claim 38.
